(19) United States
(12) Patent Application Publication
(10) Pub. No.: US 2024/0062235 A1
(43) Pub. Date: Feb. 22, 2024

(54) SYSTEMS AND METHODS FOR AUTOMATED PROCESSING AND ANALYSIS OF DEDUCTION BACKUP DATA

(71) Applicant: Cresicor Inc, Spring, TX (US)

(72) Inventors: Alexander Whatley, Houston, TX (US); Nicole Moskaluk, San Diego, CA (US); Stuart Kennedy, Longmont, CO (US); Daniel Whatley, Houston, TX (US)

(21) Appl. No.: 18/384,792

(22) Filed: Oct. 27, 2023

Related U.S. Application Data
(63) Continuation of application No. 17/018,394, filed on Sep. 11, 2020, now abandoned.
(60) Provisional application No. 62/898,762, filed on Sep. 11, 2019.

(51) Int. Cl. G06Q 30/0207; G06V 30/148

(52) U.S. Cl. CPC G06Q 30/0222; G06Q 30/0239; G06V 30/153

(57) ABSTRACT

Promotion deductions are processed by receiving a deduction backup including a deduction charge at a computing system. Details of the deduction charge are extracted from the backup and stored. The extracted details are then compared to criteria for various active promotions to determine whether the deduction charge is valid and should be consolidated, e.g., in an accounting system. Systems and methods of the disclosure also include functionality to receive and process deduction backups in various formats, to implement machine learning to perform various predictive tasks, and to automatically initiate dispute processes if a deduction charge is found to be invalid.

### CROSS-REFERENCE TO RELATED APPLICATION

This application is a continuation of and related to U.S. patent application Ser. No. 17/018,394 filed Sep. 11, 2020 entitled “Systems and Methods for Automated Processing and Analysis of Deduction Backup Data, which is related to and claims priority under 35 U.S.C. § 119(e) from U.S. Patent Application No. 62/898,762 filed Sep. 11, 2019 entitled “Deductions Invoice Scanning Module,” both of which are hereby incorporated by reference in their entirety.

### TECHNICAL FIELD

The present invention relates to systems for automatically and efficiently processing and consolidating transaction data and, in particular, the present invention relates to automatic processing and consolidation of deductions-based transactions.

### BACKGROUND

Companies regularly promote their products and services through the use of discounts or deductions. Such deductions may be offered to other entities in the supply chain (e.g., distributors, retailers, etc., collectively referred to herein as “suppliers”) with the intent that the deduction is ultimately passed on to the consumer.

Verifying and consolidating deduction charges often includes a process in which companies receive deduction charge data from suppliers and then process the deduction charge data into a useful form. The company then determines whether the charges included in the deduction charge data are valid, e.g., whether they are covered by an active promotion, and, if valid, update the company's accounting data to reflect the deduction.

Managing and tracking promotions and their associated deductions can be a very complicated and costly undertaking, particularly for large companies that, at any given time, may be promoting thousands of products or services. Further complicating matters is that each promotion may vary with respect to its duration, applicable services/products, geographic area, and the like. Accordingly, deductions processing is often a time-consuming and error-prone process. It is with these observations and issues in mind, amongst others, that various aspects of the present disclosure were conceived.

### SUMMARY

In one aspect of the present disclosure, a method of processing deductions for promotions is provided. The method includes, at a computing system, receiving a deduction backup including a deduction charge, extracting a detail of the deduction charge included in the deduction backup, and generating a deduction charge record corresponding to the deduction charge, the deduction charge record including the detail of the deduction charge extracted from the deduction backup. The method further includes determining whether the deduction charge is valid by comparing one or more fields of the deduction charge record to criteria for one or more active promotions and updating the deduction charge record based on whether the deduction charge meets the criteria of at least one of the one or more active promotions.

In certain implementations, the deduction backup is in a markup language and includes a tag corresponding to a field of the deduction charge record. In such implementations, extracting details of the deduction charge includes extracting data from the deduction backup associated with the tag.

In other implementations, the deduction backup is in a text-based format including text indicating the details of the deduction charge and extracting the detail of the deduction charge includes extracting data from the deduction backup based on a location of the text in the deduction backup. In such implementations, the method may further include executing an optical character recognition algorithm on the deduction backup to convert the deduction backup into a text-based format before extracting details of the deduction charge.

In still other implementations, the detail of the deduction backup is stored in a field of the deduction backup and the method further includes retrieving a mapping corresponding to a translation between fields of the deduction backup and fields of the deduction charge record. The method also includes applying the mapping to the field of the deduction backup.

In yet another implementation, the deduction backup includes an image of a document and extracting the detail of the deduction charge may include retrieving location information that indicates an area of the document containing the detail of the deduction charge and that is associated with a field of the deduction charge record. In such implementations, the location information may be stored as a template associated with a characteristic of the document. The method may further include receiving user input indicating the area of the document containing the detail of the deduction charge and generating the template based on the user input.

In still other implementations of the present disclosure, the method may further include initiating a dispute process responsive to determining the deduction charge is not valid. The dispute process may include automatically generating a communication from a stored dispute communication template.

In another aspect of the present disclosure, a system for processing and analyzing deduction backup data is provided. The system includes a computing device configured to receive a deduction backup including a deduction charge, extract a detail of the deduction charge included in the deduction backup, and generate a deduction charge record corresponding to the deduction charge, the deduction charge record including the detail of the deduction charge extracted from the deduction backup. The computing device is further configured to determine whether the deduction charge is valid by comparing one or more fields of the deduction charge record to criteria for one or more active promotions and update the deduction charge record based on whether the deduction charge meets the criteria of at least one of the one or more active promotions.

In certain implementations, the detail of the deduction backup is stored in a field of the deduction backup and the computing device is configured to retrieve a mapping corresponding to a translation between fields of the deduction backup and fields of the deduction charge record. The computing device is further configured to apply the mapping to the field of the deduction backup.

In other implementations, the deduction backup includes an image of a document. The computing device is configured to extract the detail of the deduction charge by retrieving location information indicating an area of the document containing the detail of the deduction charge and that is associated with a field of the deduction charge record. In such implementations, the location information may be stored as a template associated with a characteristic of the document and the computing device may be further configured to receive user input indicating the area of the document containing the detail of the deduction charge and generate the template based on the user input.

In still other implementations, the computing device is further configured to, initiate a dispute process in response to determining the deduction charge is not valid. Initiating the dispute process may include automatically generating a communication from a stored dispute communication template.

In other implementations, the deduction backup is in a text-based format including text indicating the details of the deduction charge. The computing device is further configured to execute an optical character recognition algorithm on the deduction backup to convert the deduction backup into a text-based format and to extract details of the deduction charge based on a location of the text in the deduction backup.

In yet another aspect of the present disclosure, a non-transitory computer-readable medium storing instructions is provided. When executed by a computing system, the instructions cause the computing system to receive a deduction backup including a deduction charge, extract a detail of the deduction charge included in the deduction backup, and generate a deduction charge record corresponding to the deduction charge, the deduction charge record including the detail of the deduction charge extracted from the deduction backup. The instructions further cause the computing system to determine whether the deduction charge is valid by comparing one or more fields of the deduction charge record to stored criteria for one or more active promotions and to update the deduction charge record based on whether the deduction charge meets the criteria of at least one of the one or more active promotions.

In certain implementation, the instructions further cause the computing system to retrieve a mapping corresponding to a translation between fields of the deduction backup and fields of the deduction charge record and to apply the mapping to the field of the deduction backup.

In other implementations, the deduction backup includes an image of a document. In such implementations, the instructions are further configured to cause the computing system to extract the detail of the deduction charge by retrieving location information indicating an area of the document containing the detail of the deduction charge and that is associated with a field of the deduction charge record. Also in such implementations, the location information may be stored as a template associated with a characteristic of the document. The instructions may further cause the computing system to receive user input indicating the area of the document containing the detail of the deduction charge and to generate the template based on the user input.

In still another implementation, the instructions are further configured to cause the computing system to initiate a dispute process in response to determining the deduction charge is not valid. Initiating the dispute process may include automatically generating a communication from a stored dispute communication template.

### BRIEF DESCRIPTION OF THE DRAWINGS

FIG. 1 is a system diagram of an example operating environment in which a deductions management system in accordance with various implementations of the present disclosure may operate;

FIG. 2 is a flow chart illustrating a method for receiving and processing deduction data;

FIG. 3 is a flow chart illustrating a method for processing deduction backups; and

FIG. 4 is a system diagram of an example computing system that may implement various systems and methods discussed herein, in accordance with various embodiments of the present disclosure.

### DETAILED DESCRIPTION

Many companies market and sell their goods through a broad variety of distribution and retail companies. As each of the distributors and retail companies have different business processes and differing accounting and inventory management systems, the resulting trade process can be complex and cumbersome for companies to manage.

One common aspect of trade processes is the management of trade promotions. Trade promotions are marketing techniques and events that are created to increase demand for the company's products. As part of the promotion a company will offer discounts to the retailers, distributors, or other business entities in the supply chain (collectively referred to herein as “suppliers”) which will then be passed on to consumers to persuade the consumer to buy the promoted product. These promotions can be in many different forms; however, each promotion generally requires that the company reimburse at least one of the suppliers for the discounted cost of the product. To claim such discounts, suppliers will typically pay the company less than what is billed on an original shipping invoice with the reduced payment reflecting any discounts and other reduced charges corresponding to any applicable promotions.

The difference between what is billed by the company on the original shipping invoice and what is finally paid by the supplier is known as a deduction. Generally, suppliers that claim discounts provide transaction information to the company corresponding to any transactions for which a promotion may be applicable. The company then processes the transaction information to reconcile any differences between the original shipping invoice and the amount paid by the supplier.

The transaction information provided by suppliers to the company is generally referred to as backup or deduction backup. Suppliers may provide deduction backups in multiple formats and each deduction backup may consist of hundreds or thousands of individual charges, each charge corresponding to an individual sale for which a discount is being claimed. For each charge, the deduction backup may include information including, among other things, a date of transaction, a time of transaction, a retailer at which the transaction occurred, and the like. Accordingly, to properly reconcile deductions, companies must extract and process all of the charges in each deduction backup they receive and then confirm that each charge contained in each deduction backup corresponds to a valid promotion. The company can then update any accounting records accordingly.

To properly account for deductions and maintain accurate financial records, companies that offer promotions must integrate and reconcile deductions with the amount originally billed. Trade promotions are very common and discounts due to promotions may comprise a substantial percentage of a company's gross revenues. Additionally, deduction backups are often manually curated and issued by suppliers, introducing human error into the creation of these documents. Thus, companies have a critical interest in analyzing deduction information to both maintain accurate financial records, and also to track and determine the efficiency and profitability of trade promotions.

Currently, deduction processing and management is an inefficient and time-consuming process for several reasons. First, deduction backups may be supplied in a variety of different formats which are difficult for companies to integrate and reconcile. For example, suppliers for a given company may provide deduction backups as hard copy records or scans/photocopies thereof, spreadsheets, text files, portable document format (PDF) files, and the like. Notably, any of the foregoing formats may include omissions and at least some of the formats (e.g., scans/photocopies) can be highly prone to damage, blurring, etc. that make processing more difficult. Deduction backups may also be provided through multiple channels including, without limitation, by mail, by email, through web portals, and the like, further complicating deductions management and processing. No common standards exist for the deduction backups. Accordingly, companies typically hire trade analysts and data entry staff to manually transcribe the backup deductions charges into a deduction system line by line. To the extent any of the hard copy data is incomplete or degraded, (e.g., blurred from photocopying or damaged), the difficulty of entering and analyzing the deduction data is made significantly more laborious and time-consuming.

Another reason for the inefficiencies of conventional deduction management is that even after charges from a deduction backup have been processed, trade analysts still have to match each deduction item against a promotion that the company has run. This generally requires the analyst to go back and forth between the company's deductions system and trade promotion system, and match the deduction to the promotion using the common fields of customer, product, dates, and other fields through manual searching. Adding to the complexity of the matching process, the fields used to match deduction charges and promotions can be misaligned, requiring significantly greater diligence and care when matching.

In light of the foregoing complexities, matching even a single deduction to a promotion can be a painstaking and error-prone process in which an analyst must to run multiple queries and carefully analyze the results of each query. Because companies may receive data for thousands of promotion-related charges, each of which must be matched against thousands of promotions that may be simultaneously running at any given time, this matching process may take analysts countless hours every month.

After all of the deductions items have been processed and verified, any items that could not be matched to existing promotions must be disputed with the deductions issuer, which may consist of extended email correspondence and different forms of follow up. This dispute process often necessitates filling out dispute forms and lengthy communications exchange with the supplier trying to claim the invalid deductions.

If errors are not found and corrected during the matching process, financial harm to the company can result. In one common example situation, deductions are claimed by suppliers outside of a promotion's timespan, which results in an incorrect/invalid deduction charge to the company. To the extent such invalid deduction charges are not identified and addressed, a corresponding decrease in the company's profitability and cash flow would result.

To address the foregoing issues, among others, the present disclosure is directed to systems and methods for managing and processing deductions. To that end, aspects of the present disclosure are directed to various steps in the deduction management process including, without limitation, automated transcribing/extraction of data from deduction backup, matching of deduction charges to active promotions, and disputing invalid deduction charges. Systems and method of the present disclosure are specifically configured to work with multiple forms of deduction backups while also addressing problems associated with damaged, incomplete and/or degraded deduction backup data.

As described below in further detail, a deductions management system according to the present disclosure may receive deduction backups in various digital formats, e.g., by download by the system or by upload to the system by a user (e.g., a user associated with a company running promotions or a supplier taking advantage of promotions offered by a company). Deduction charges from the deduction backup is then extracted and converted into a standardized format. Among other things, the extracted data may include, for each charge in the deduction backup, the supplier claiming the deduction, the product/service sold (or group of the product/service), the date of the transaction, and other similar fields related to the transaction for which a discount is being claimed. The extracted data is converted as needed and stored, e.g., in a database, of the deductions management system. Each deduction charge is then cross-referenced to determine if the deduction charge is valid (e.g., corresponds to a current promotion) and should be reconciled, is invalid and should be disputed, or requires follow-up (e.g., due to incomplete or conflicting information). The resulting data may then be made available for the company for updating its accounting systems, analyzing promotions, etc. For example, the system may make the foregoing information available to a user via an application, web portal, or similar interface. To the extent a deduction charge is to be disputed, the deductions management system may be used to initialize and track the resulting dispute.

Systems and methods according to the present disclosure include various features that facilitate processing and management of deduction charges. One such feature is the ability to read and extract deduction charge data from a wide variety of formats (including, but not limited to hard copy documents) from a wide range of suppliers. In one example process for hard copy files, a scanned document (e.g., in PDF or similar format) may be processed using a text extraction engine. If the file is text-based or includes underlying text elements, words in the file may then be extracted directly by the engine and processed to extract the deduction charge data. Alternatively, an optical character recognition (OCR) process (or other text-recognition process) may be applied to the file to extract the text it contains, which may then be analyzed as previously noted.

In certain implementations, systems according to the present disclosure may extract deduction charge data from multiple files or records having the same deduction backup format and integrate all of the extracted data in a single processing step. More specifically, a deduction backup provided by a supplier may include multiple files and data records. This is generally because the deduction charges may correspond to promotions run at different stores/facilities operated by the supplier or during different date ranges. Accordingly, systems and methods disclosed herein can extract the deduction charge data from multiple deduction backups and concatenate the extracted data into a single data source. By doing so, the extracted data may be efficiently processed and more meaningful information regarding promotions may be presented to users of the deductions management system.

In certain implementations, systems described herein check, validate, and/or extract deduction charge data from deduction backups by matching and comparing deduction backups to a library of templates or similar objects for translating between data as stored in the deduction backup and data as stored in a deduction charge data store (e.g., a database). Each translation object may correspond to a different format of deduction backup and may indicate where in the corresponding deduction backup relevant deduction charge data may be found and/or to what field of the deduction charge data source the relevant data corresponds. Accordingly, by referring to a translation object, the deductions management system may readily process documents in a wide range of formats including, but not limited to, non-standard or supplier-specific formats.

In certain implementations, systems in accordance with the present disclosure may provide an interface that allows users to identify where in a deduction backup relevant data is found. For example, the interface may present a visual representation of the deduction backup to the user along with various tools (e.g., selection boxes, lassos, etc.) for identifying areas corresponding to relevant data. The system may then generate a new template or update an existing template based on the user's selections. As a result, users may easily update the template library as deduction backup formats are updated or new deduction backup formats are added.

In yet another feature of systems and methods according to this disclosure, a machine learning engine may be used to analyze and populate data where the deduction backup may be damaged, incomplete or degraded, particularly in instances where the deduction backup is provided as a hard copy document or scan thereof. Without limitation, a machine learning engine may be trained using examples of blurred or incomplete deduction backups that are subsequently annotated or otherwise manually analyzed. For example, such files may be annotated using bounding boxes around the relevant deduction charge data. The training data may then be provided to the machine learning engine such that the machine learning engine learns to identify where in the deduction backup certain deduction charge-related data is located. To the extent deduction charge-related data may be missing, degraded, or otherwise incomplete, the machine learning engine may also predict values for the incomplete data. The machine learning engine may also be used to automatically identify charge-related data in novel deduction backup formats. To the extent the machine learning engine is unable to identify certain data for a charge of a deduction backup, the charge may be flagged or otherwise marked for manual review. Similarly, if the machine learning engine predicts data for a given charge, such predicted data may also be flagged or otherwise marked for manual review. The results of any such manual review may then be provided to the machine learning engine as additional training data/feedback to further refine the models of the machine learning engine.

As noted above, systems according to the present disclosure may implement a machine learning engine and associated algorithms/models to predict missing or incomplete data. In other implementations, machine learning engine may also be used to capture relevant data from files and backups in formats that are new to the system. In one example, the machine learning engine may predict which fields, tags, labels, etc. of the deduction backup correspond to fields of a deduction charge data source (e.g., a database) containing standardized deduction charge data. As another example, the system may predict where in the new deduction backup relevant data may be located. In the event the machine learning engine is unable to make a prediction or unable to make a prediction with sufficient confidence (e.g., due to the backup being too degraded damaged, etc.), the system may flag certain deduction backups or records of the deduction charge data source for manual review, entry, verification, reconciliation, etc.

After extracting relevant data from a deduction backup, systems of the present disclosure attempt to match each deduction charge to a corresponding promotion. In certain implementations, such pairing/matching is conducted by examining values of common fields such as customer, product, dates, etc. To do so, the system may use a machine learning engine that is able to fuzzily match the common fields. For each deduction charge, the machine learning engine may then suggest one or more promotions that match the deduction charge, indicate that no promotion matches the deduction charge, indicate the deduction charge is or may be invalid, or take other similar steps. In certain implementations, the resulting match information is stored along with each deduction charge record. As a result, the match information is easily exportable in various formats such that companies may use it to update accounting and analyze promotional activity.

Systems disclosed herein may also facilitate the deduction dispute process. For example, systems according to the present disclosure may automate at least part of the process of generating and logging disputes in response to identifying invalid deduction charges. Without limitation, the system may store and automatically generates various forms and communications as part of the dispute process. In certain implementations, the system may provide an interface through which users may generate and/or modify email (or other communication) templates. The system may also be configured to track and integrate communication threads associated with particular disputes. The interface may also allow for disputes to be tracked and analyzed, e.g., by their current status, and to be closed once the dispute is resolved.

In summary, systems and methods according to the present disclosure may be used to automate various aspects of deduction processing. Among other things, such automation can save many hours in manual data entry and data matching, eliminate errors from manual entry, and allow more efficient analysis of promotion activity by the companies using the system. The further ability to facilitate the dispute of invalid deductions may further save companies significant costs associated with invalid charges.

Testing of aspects of the present disclosure indicate that significant time and cost savings may be realized through the systems and methods disclosed herein. For example, based on testing results, systems in accordance with the present disclosure are estimated to reduce labor costs by 80-95% for each of promotion entry/upkeep (e.g., creation of new promotions and/or managing existing promotions), deductions processing (e.g., intake of deduction charges), and deductions matching (e.g., matching deduction charges to corresponding active promotions). One particular test based on a moderately sized company also resulted in time savings of up to 80 hours per week across analysts (e.g., sales/trade analysts and finance/deductions analysts) that conventionally manage deductions and promotions. These times savings expanded to about 130 hours per week when considering all stakeholders involved in the management and processing of promotions and deductions. Even for a moderately sized company, such improvements significantly reduce costs and lead to a more efficient workforce. Nevertheless, it should be appreciated that such results are scalable based on the number of active promotions and deduction charges for a given company such that larger companies or companies with more promotions could see substantially greater benefits from implementing the systems and methods provided.

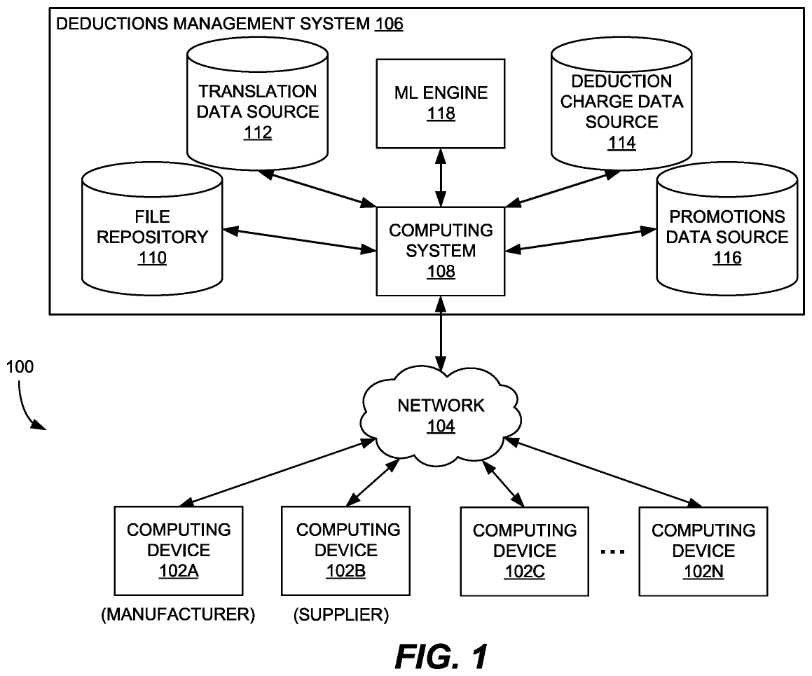

FIG. 1 is a diagram illustrating an example operating environment 100 in which systems and methods according to the present disclosure may be implemented. As illustrated, the operating environment 100 includes one or more computing devices 102A-102N in communication with a deductions management system 106 over a network 104. Although illustrated in FIG. 1 as a single network, in other implementations, network 104 may be one of multiple networks facilitating communication between the computing devices 102A-102N and deductions management system 106.

Computing devices 102A-102N may be any of a variety of computing devices. For example, and without limitation, computing devices 102A-102N may be personal computers (e.g., laptop or desktop computers), server systems, smart phones, tablets, or any other similar computing device. Stated differently, computing devices 102A-102N may be any suitable computing device capable of performing the functions described herein.

In certain implementations, at least one of computing devices 102A-102N, e.g., computing device 102A, corresponds to an entity offering promotions. In such implementations, computing device 102A may be used to access data stored by deductions management system 106, to retrieve reports and other analytics from deductions management system 106, to configure deductions management system 106, and the like. Computing devices 102A-102N may also include one or more devices, e.g., computing device 102B, corresponding to a business entity (e.g., a distributor or retailer) that submits deduction data. In such implementations, computing device 102B may be limited to simply submitting deduction backups or similar deduction data to deductions management system 106. However, in at least some implementations, computing device 102B may also be used to access data of deductions management system 106 pertinent to the user of computing device 102B. Such data may include, among other things and without limitation, status information regarding previously submitted deduction reimbursement requests, historical reimbursement data, various reports and analytics, and the like. In any case, computing devices 102A-102N may access deductions management system 106 in any suitable way including, but not limited to, via a deduction management application executed on computing devices 102A-102N or via a web site accessible by a web browser running on computing devices 102A-102N.

For purposes of the present disclosure, the term “manufacturer” is generally used to refer to a first party or entity that offers a discount/promotion while the term “supplier” is used to refer to a second party or entity claiming the discount. More generally, however, systems and methods disclosed herein facilitate processing of deductions associated with promotions offered by a first party/entity and that may be taken advantage of by a second party. The first party and the second party may have any suitable business relationship. As a result, any reference to a particular business entity or role (e.g., manufacturer, distributor, retailer, etc.) is intended merely as an example and should not be considered limiting.

Deductions management system 106 may be implemented using one or more computing devices or systems, e.g., computing system 108. Moreover, deductions management system 106 may be implemented as either a centralized/local system or a distributed system environment. In at least certain implementations, the deductions management system 106 may be implemented, at least in part, in a cloud-based or similar computing environment.

Computing system 108 of deductions management system 106 may be communicatively coupled to or otherwise have access to one or more data sources for facilitating the various functions described here. A data source may be in any form that permits reading and/or writing of data from the data source by the computing system 108, and includes, but is not limited to, a database or file repository. For example, as illustrated in FIG. 1, computing system 108 is communicatively coupled to each of a file repository 110, a translation data source 112, a deduction charge data source 114, and a promotions data source 116, each of which is described below in further detail. Notably, while illustrated in FIG. 1 as being separate databases/data sources, any or all of the data sources 110-116 may be combined into one or more data sources. For example, each of the deduction charge data source 114 and the promotions data source 116 may be maintained as one or more tables in a common database. For purposes of the present disclosure and for clarity only, data sources 110-116 will generally be referred to as separate and independent data sources; however, it should be understood that data sources 110-116 are to be considered only one example of how data may be stored for use in systems and methods according to the present disclosure.

During operation, and as described below in further detail, computing system 108 of deductions management system 106 receives deduction backups from one or more of computing devices 102A-102N. Generally, a deduction backup includes information regarding one or more transactions for which a deduction may be applicable and should not be considered to be limited to any particular file type, structure, or format. Rather, as noted below, certain implementations of the present disclosure are configured to handle deduction backups having multiple formats ranging from, but not limited to, highly structured and standardized backup formats to scanned images of receipts, invoices, etc. lacking any underlying text elements. In certain implementations, computing system 108 may store the as-received deduction backups, such as in file repository 110.

After receiving a deductions backup, computing system 108 processes the deduction backup data to identify and extract deduction charge data from the deduction backup. Computing system 108 may then then store the deduction charge data, for example, in deduction charge data source 114.

In certain implementations, computing system 108 may rely on one or more templates, annotated example files, maps, or similar objects when processing deduction backups and extracting deduction charge data. Generally, each such translation object provides information for translating data as contained in a deduction backup into a format suitable for storage in deduction charge data source 114. Each translation object may be stored in translation data source 112. For example, the deductions management system 106 may store one or more templates for scanned deduction backups. Each template may include, for a respective format of deduction backup, information (e.g., user-provided annotations) to identify where certain relevant data (e.g., date, supplier name/address, list/table of transactions, etc.) can be found in the deduction backup and to which field of deduction charge data source 114 each piece of relevant data corresponds. In other implementations, computing system 108 may refer to a map, dictionary, table, etc. that provides relationships between fields of the deduction backup and the corresponding fields of deduction charge data source 114. Accordingly, translation data source 112 generally contains a library of translation objects for use by computing system 108 in extracting relevant data from deduction backups received by deductions management system 106.

After deduction charge data has been extracted and stored in deduction charge data source 114, computing system 108 may then compare the entries of deduction charge data source 114 with a list of promotions stored in promotions data source 116. To the extent a deduction charge meets the requirements of a promotion included in promotions data source 116, the corresponding record of deduction charge data source 114 may be marked for reimbursement or similar processing. Similarly, if a deduction charge is not covered by a current promotion or invalid, the corresponding record of deduction charge data source 114 may be marked as rejected and/or requiring further review. In certain instances, deductions management system 106 may also initiate a dispute process in response to determining a deduction charge is invalid.

In certain implementations, deductions management system 106 may correspond to a computing system owned and operated by a manufacturer, e.g., an in-house computing system. In other implementations, deductions management system 106 may be operated by a third party and various features and functionality of the deductions management system 106 described herein may be provided, for example, as software as a service to one or more manufacturers.

Deductions management system 106 may further include a machine learning engine 118 communicatively coupled to or otherwise accessible by computing system 108. Machine learning engine 118 may include, among other things, models, algorithms, data, training data, and the like for purposes of providing machine learning functionality for deductions management system 106. As discussed below in further detail, at least some of the machine learning functionality provided by machine learning engine 118 may include, without limitation, automatic classification and processing of deduction backup(s), automated processing of new deduction backup formats, automatic matching of deduction charges to promotions, and prediction of missing or incomplete data.

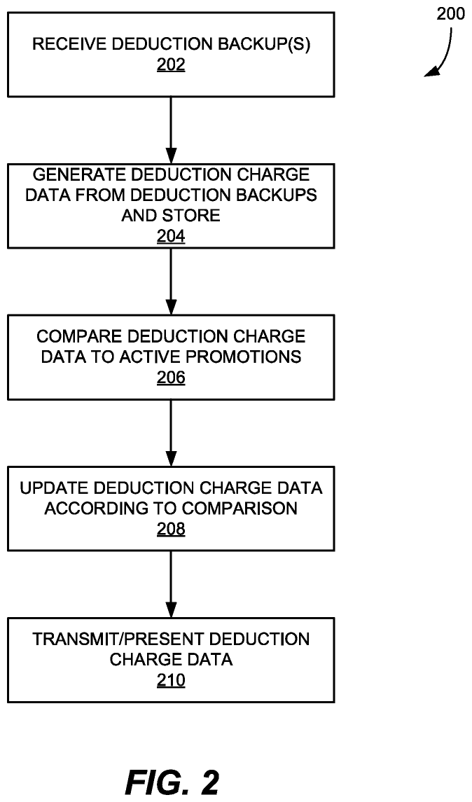

FIG. 2 is a flow chart illustrating a method 200 for receiving and processing deduction data. Although not limited to the operational environment 100 of FIG. 1, in at least certain implementations, method 200 may be performed by a central system, such as the deductions management system 106 discussed above. reference in the following discussion is made to the operational environment 100 is made for clarity only. Stated differently, reference to deductions management system 106 and other elements of the operation environment 100 of FIG. 1 should be regarded merely as a non-limiting example intended to illustrate various aspects of the present disclosure.

At operation 202, the deductions management system 106 receives a deduction backup from a computing device 102B corresponding to a supplier. Although the specific content of the deduction backup may vary, the deduction backup generally includes information for transactions associated with the supplier for a given time period and for which the supplier believes a discount applies due to the transactions being covered by a promotion offered by a manufacturer. Data included in a deduction backup may include information regarding one or more transactions and for each transaction may include one or more details such as, without limitation, an identifier of the purchased product (e.g., product name, serial number, UPC code, SKU number, or other similar product identification data), a product group of the purchased product, a time of purchase, a date of purchase, a cost, a quantity of product, the supplier from which the purchase was made, a store at which the purchase was made, or a geographic location (e.g., city, state, region, country) of the purchase.

At operation 204, deductions management system 106 processes the deduction backup received in operation 202 to generate standardized deduction data, referred to herein as deduction charge data. In general, deductions management system 106 processes the deduction backup by identifying information within the deduction backup that may be used to determine whether a promotion and corresponding deduction applies, extracting that information, and then storing the extracted information in a standardized format, e.g., within the deduction charge data source 114 of FIG. 1.

Suppliers may generate and provide deduction backups in a wide range of formats. Accordingly, in certain implementations of the present disclosure, processing of a deduction backup by deductions management system 106 may include deductions management system 106 identifying the format, type, etc. of the deduction backup and executing a corresponding processing routine to extract and store the relevant deduction data. More generally, deductions management system 106 may identify a processing routing based on one or more characteristics of the deduction backup.

In a first example, the supplier may provide the deduction backup in a standard format (e.g., a tabular format) in which the fields of the deduction backup directly correspond to the fields and structure of deduction charge data source 114. In such implementations, deductions management system 106 may verify that the deduction backup is in a standard format (e.g., by verifying a file extension or names of fields within the deduction backup) and may then execute an insertion operation in which the data contained in the deduction backup is added to deduction charge data source 114 with little or no modification.

In a second, similar example, the deduction backup may be provided in a structured format, such as a predefined Extensible Markup Language (XML) file or a tagged PDF file, in which the deduction backup file includes tags, labels, or similar indicators that identify particular data elements. Deductions management system 106 may then parse or otherwise interpret the deduction backup to extract the data elements based on the tags, labels, etc. and then store the extracted data elements as entries in deduction charge data source 114. For example, and without limitation, a deduction backup may include pairs of tags (e.g., an opening tag (e.g., “<transaction>”, “<\transaction>”)) indicating each transaction. Between each pair of transaction tags, further pairs of tags corresponding to details (e.g., date, amount, product sold, etc.) of the transaction may be included. Accordingly, deductions management system 106 may be configured to process the deduction backup by identifying each transaction and its corresponding details and inserting a corresponding record into deduction charge data source 114.

In certain implementations, the tags, labels, fields, etc., of the deduction backup file may not correspond directly to the fields of deduction charge data source 114. In such implementations, deductions management system 106 may refer to a map, dictionary, glossary, etc. stored, e.g., in translation data source 112, that links or otherwise defines relationships between fields of the deduction backup file and those of deduction charge data source 114. Deductions management system 106 may then perform a corresponding translation of the data in the deduction backup and insert the data into deduction charge data source 114 in the appropriate fields.

In a third example, the deduction backup may be in an unstructured text-based file or other file containing text data (e.g., a PDF file containing text elements). In such cases, deductions management system 106 may process the deduction backup by looking for certain words, symbols, phrases, etc. within the deduction backup corresponding to relevant deduction data. For example, deductions management system 106 may search for strings corresponding to product identifiers, locations, supplier names, costs, and the like within the deduction backup and, based on the relative location of the searched strings within the deduction backup. Deductions management system 106 may then generate corresponding records for in deduction charge data source 114.

In a fourth example, the deduction backup may be an image file, such as a scanned document. In such cases, deductions management system 106 may process the deduction backup by executing an optical character recognition (OCR) algorithm on the image file to identify text within the image file. After executing the OCR algorithm, deductions management system 106 may process the generated text data as discussed above (e.g., by searching for strings within the text data corresponding to fields of the deduction charge data source 114).

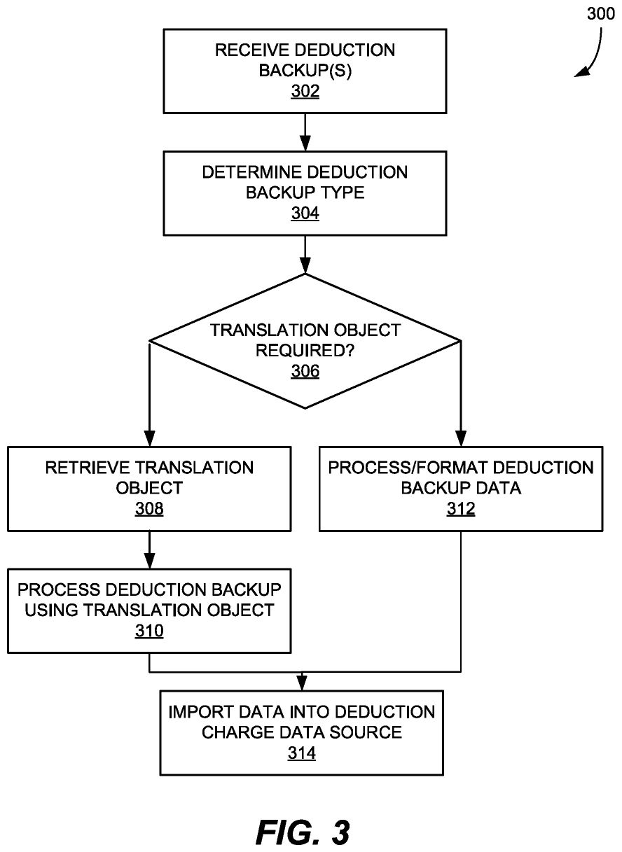

In certain implementations, processing of the deduction backup may be facilitated by the use of one or more translation objects. Such translation objects may include, among other things and without limitation, templates, annotated files, maps, and the like for identifying where certain data is located within the deduction backup and/or how data contained in the deduction backup corresponds to the various fields of deduction charge data source 114. Implementation of translation objects is discussed below in further detail in the context of FIG. 3.

The deduction backup may include incomplete data or may not able to be fully read and processed by deductions management system 106. In such cases, accordingly, to the extent deductions management system 106 is unable to find, extract, or otherwise process certain pieces of key data for a given deduction charge, deductions management system 106 may transmit a prompt, message, etc., to a user associated with the manufacturer or otherwise log the incomplete deductions request for further manual review and completion.

Any of the foregoing processes for extracting data may be implemented, at least in part, using machine learning engine 118. For example, machine learning engine 118 may include algorithms or models for any of identify deduction backup formats, predicting incomplete or missing data of the deduction backup, translating data in the deduction backup to corresponding fields of deduction charge data source 114, and the like. Additional details regarding features and functions for which machine learning engine 118 may be applied are discussed below in further detail.

At operation 206, deductions management system 106 compares each entry of the deduction charge data generated in operation 204 to criteria for promotions to determine whether one or more promotions may apply to the deduction charge. To do so and for each of one or more records of deduction charge data source 114, deductions management system 106 may access promotions data source 116, which contains a list of promotions, and may determine whether information included in the record meets the criteria for one or more promotions included in promotions data source 116.

Generally, promotions data source 116 includes information related to various promotional offers from the manufacturer. More specifically, the information contained in promotions data source 116 includes both the criteria for receiving a deduction (e.g., date of purchase, date of deduction charge submission, product/service sold, location of sale, etc.) and the nature of the deduction (e.g., amount of the deduction). Promotions data source 116 includes active promotions but may also include past/expired promotions and/or upcoming promotions as well.

The term promotion is generally used to refer to a promotional event or sale, while each product/service or product/service group included in the promotional event is referred to as a promotion line of the promotion. Accordingly, in certain implementations, the data contained in promotions data source 116 may be similarly organized into promotion objects, entries, etc., corresponding to a promotional/sales event, each of which is linked to or otherwise contains one or more promotion line objects, entries, etc., corresponding to a respective promotion line.

In light of the foregoing, promotions data source 116 may include one or both of criteria and deduction details that apply broadly to entire promotions and/or criteria and deduction details that apply to one or more specific promotion lines within a promotion. For example, promotions data source 116 may include an entry corresponding to a “Summer Promotion” with a start date of June 15 and an end date of August 31. Each promotion line object/entry associated with the promotion object/entry for the Summer Promotion may further specify a product or product group subject to the Summer Promotion and a corresponding deduction amount for that product or product group. Accordingly, deductions management system 106 may determine if a given deduction charge is valid by determining if the transaction corresponding to the deduction chargefalls within the date range of the Summer Promotion and includes a product included in one of the product line objects/entries associated with the Summer Promotion.

At operation 208, deductions management system 106 updates records of deduction charge data source 114, based on their validity, e.g., whether the record is covered by an active promotion. For example, deduction charge data source 114 may include a status for each deduction charge. Prior to operation 206, during which records are evaluated to determine whether they are subject to active promotions, the status field may be empty or otherwise indicate that the deduction charge is pending evaluation by the system. If, during operation 206, deductions management system 106 determines an active promotion is applicable, the field may be updated to indicate that the deduction charge is valid. The record may also be updated to identify the particular promotion that is applicable, e.g., by adding a promotion ID or similar value to the deduction charge record. The record may also be updated to indicate the amount of the corresponding deduction. If, on the other hand, deductions management system 106 determines an active promotion is not applicable, the deduction charge may be marked as invalid. Alternatively, deduction charges that are identified as invalid may be flagged for further review/approval.

In certain implementations, deductions management system 106 may be configured such that each promotion in promotions data source 116 includes a unique combination of characteristics. For example, when a user adds a new promotion to promotions data source 116, deductions management system 106 may determine whether another promotion having the same characteristics (e.g., retailer, date range, etc.) is already stored in promotions data source 116. If so, deductions management system 106 may prevent addition of the new promotion to promotions data source 116 and/or may alert the user that a duplication exists. In other implementations, deductions management system 106 may permit overlapping promotions in promotions data source 116 and, as a result, deductions management system 106 may determine that more than one promotion is applicable to a given deduction charge. In such cases, to determine which promotion to apply, deductions management system 106 may be configured to perform various actions including, but not limited to, applying a specific promotion identified in the deduction backup, applying the promotion resulting in the greatest or smallest deduction, applying the most recent promotion, or applying any other similar business rules for choosing between promotions. Alternatively, deductions management system 106 may mark or otherwise flag any deduction charges for which multiple promotions may be applicable for further review.

Following completion of method 200 of FIG. 2, the deduction charge data may be used by deductions management system 106 in various ways (operation 210). For example, in certain implementations, if deductions management system 106 determines that one or more deductions are valid, deductions management system 106 may generate and transmit a report, notification, email, or similar communication to an email account, etc. associated with an accounting department or other department responsible for processing deductions-related payments. In certain implementations, deductions management system 106 may be configured to directly interface with an automated accounting system and to provide the information related to any deductions to the accounting system in a suitable format for processing and reconciliation.

As another example, deductions management system 106 may provide information related to summaries, analytics, trends, and the like of the deduction charge data. In certain implementations, such information may be provided to users associated with the manufacturer for various purposes including, among other things, determining the efficacy of particular promotions. Information corresponding to the updated deductions data for a given supplier may also be provided to a user associated with the supplier for various purposes including, among other things and without limitation, tracking the status of pending deduction charges.

Information related to the deduction charge data may be provided in various forms. For example, deductions management system 106 may be configured to automatically generate and distribute one or more reports related to the updated deductions data. In other implementations, a user may access information related to the updated deductions data through an application, web browser, etc. For example, in one specific implementation, a user may log into a website and be presented with various graphical, tabular, or other similar visual representations and analytics related to relevant portions of the updated deductions data. The user may also be able to dynamically filter, pivot, or otherwise change what and how certain data is presented to further facilitate analysis.

In yet another example, the deduction charge data may be used to support a dispute process. For example, deductions management system 106 may facilitate the process of disputing any deduction charges identified as invalid by automatically generating various forms and communications that may be used to dispute deduction charges. Deductions management system 106 may further track the status of any such disputes. Among other things, deductions management system 106 may at least partially complete an email template that may then be presented to a user for review and modification. In such implementations, deductions management system 106 may also be configured to track email communications threads and other forms of communications associated with a given dispute. As a result, disputes may be automatically initiated by deductions management system 106, thus saving the user significant time. Moreover, dispute tracking and analysis tools further increase the likelihood that a dispute will be resolved in an efficient and timely manner.

FIG. 3 is a flow chart illustrating a method 300 for processing deduction backups. For purposes of context and clarity only, the following discussion references various elements of the operating environment 100 illustrated in FIG. 1.

In general, method 300 illustrated in FIG. 3 is executed by deductions management system 106 and, more specifically, computing system 108. The method 300 generally includes deductions management system 106 receiving a deduction backup and determining how data contained in the deduction backup is to be imported into deduction charge data source 114 and, therefore, standardized. In certain cases, data of the deduction backup may be in a format that requires translating the data as contained in the deduction backup into a format suitable for importation into deduction charge data source 114. Such translation is facilitated by what is referred to herein as “translation objects”, which, for purposes of the present disclosure, include, without limitation, executable files, templates, maps, tables, and other objects for use in converting or translating data in the deduction backup for storage in the deduction charge data source 114.

Referring to FIG. 3, at operation 302, the deductions management system 106 receives a deduction backup from a computing device associated with a supplier, e.g., computing device 102B of FIG. 1. At operation 304, deductions management system 106 determines a type of the deduction backup. For example, deductions management system 106 may determine a type of deduction backup based on a file extension of the deduction backup, contents of the deduction backup, metadata of the deduction backup, or any other characteristic of the deduction backup.

Based on the type of deduction backup, deductions management system 106 may take various approaches to import data contained in the deduction backup into deduction charge data source 114. In general; however, deductions management system 106 determines, based on the type of deduction backup, whether a translation object is required (operation 306) and, if so, retrieves the translation object (operation 308). The deductions management system 106 then processes the deduction backup according to the translation object (operation 310). If a translation object is not required, deductions management system 106 may nevertheless perform some processing/formatting on the data of the deduction backup (operation 312). In either case, deductions management system 106 imports the data into deduction charge data source 114 (operation 314).

Referring back to operation 306, deductions management system 106 may determine whether a translation object is required in several different ways. For example, deductions management system 106 may determine whether a translation object is required based on, among other things and without limitation, a file extension or type of the deduction backup (e.g., whether the deduction backup is a text-based file, an image file, etc.), content of the deduction backup (e.g., whether the deduction backup includes text elements, tags or other structural elements, etc.), or the sender/supplier of the deduction backup. Deductions management system 106 may also determine that a translation object is required in response to user input. For example, and without limitation, when uploading the deduction backup, a supplier may indicate a file type/format of the deduction backup or provide other, similar information from which deductions management system 106 may determine application of a translation object is necessary. As another example, a manufacturer may establish business rules that are stored and accessible by deductions management system 106 for purposes of determining whether deduction backups having certain characteristics require translation to conform to the manufacturer's other systems.

The type of translation object retrieved in operation 308 and applied in operation 310 may vary depending on the type of deduction backup. For example, in certain implementations, the deduction backup may be received in a tabular or other structured form in which the data of the deduction backup is provided with corresponding labels, tags, fields, or other similar identifiers for the data. In such cases, the translation object may be a map, dictionary, or similar data structure that links the identifier of the deduction backup to a corresponding field of deduction data source 114. Deductions management system 106 may then apply the translation object by generating a record in which the identifiers of the deduction backup are replaced with those of deduction data source 114, such that the record may be readily inserted into deduction data source 114.

As another example, the deduction backup may be received in a format without embedded text elements, such as an image. In such cases, the translation object may be a template or similar object indicating the location of relevant data within the deduction backup. For example, deductions management system 106 may store and maintain a template for a supplier that provides deduction backups in an image-based format. For each piece of relevant data in the deduction backups, the template may include, for example and among other things, the location of the data in the deduction backup and the corresponding field of deduction data source 114. The template may store the location of the data in any suitable way; however, in at least one implementation, the location is stored as coordinates defining a bounded area of the image of the deduction backup. To apply the template translation object, deductions management system 106 may perform an OCR process or similar text-recognition process within each bounded area of the template and then populate a record including the corresponding field of deduction data source 114. The record may then be inserted into deduction data source 114.

In certain instances, a translation object for a given deduction backup may not be available. In such cases, deductions management system 106 may request translation information from which a translation object may be generated. For example, in cases in which the translation object is in the form of a map, deductions management system 106 may present a user interface to a user (e.g., a user of computing device 102A associated with the manufacturer) in which the user can link a source field corresponding to a field included in the deduction backup to a destination field corresponding to a field included in the deduction charge data source 114. The resulting mapping may then be stored in the translation data source 112 for future reference by deductions management system 106 for purposes of translating deduction backups received in the future.

As another example, in cases in which the translation object is in the form of a template, deductions management system 106 may present a user interface to a user (e.g., a user of computing device 102A associated with the manufacturer) in which deductions management system 106 presents a visual representation of the deduction backup. The user interface may include various tools for identifying certain areas of the visual representation such as, but not limited to, selection boxes, selection lassos, text cursors, etc. Responsive to the user selecting a particular area of the visual representation, deductions management system 106 may request that the user identify the information contained within the identified area, e.g., by identifying the field of deduction charge data source 114 to which the identified area corresponds. Alternatively, deductions management system 106 may iterate through some or all of the fields of deduction charge data source 114 and ask the user to identify where in the visual representation the corresponding data may be found, e.g., by using the aforementioned selection tools. In either case, deductions management system 106 may generate a template based on the selections made by the user and store the template as a translation object in the translation data source 112. In certain implementations, for example, deductions management system 106 may generate a template that includes a list of coordinates or other similar definitions of the selection paired with corresponding data field of deduction charge data source 114 and subsequently store the generated list in translation data source 112.

Systems according to the present disclosure may implement one or more machine learning or similar algorithms to further improve the efficiency with which deduction backups may be processed.

In a first implementation, deductions management system 106 may apply a machine learning algorithm/model to process deduction backups received by deductions management system 106 in an unknown format. In such implementations, deductions management system 106 may analyze characteristics of the new deduction backup and predict what information contained in the new deduction backup is to be extracted and stored in deduction charge data source 114. For example, deductions management system 106 may execute a machine learning algorithm that identifies tags, labels, fields, etc. in the new deduction backup and automatically predicts to which fields of deduction charge data source 114 they correspond. As part of this process, deductions management system 106 may generate a map (or similar object) linking fields of the deduction backup to those of deduction charge data source 114 and may store the map in translation data source 112 for use in processing subsequent deduction backups having the novel format.

In another implementation, deductions management system 106 may receive a deduction backup as an image or similar format for which a template is unavailable. Deductions management system 106 may then execute a machine learning algorithm that, based on visual and other characteristics of the deduction backup, predicts where in the deduction backup relevant data is located. In at least certain implementations, deductions management system 106 may use such predictions to generate a template for the new deduction backup format and store the template in translation data source 112.

In still another implementation, deductions management system 106 may apply one or more machine learning algorithms to predict missing or incomplete data of the deduction backup. For example, deductions management system 106 may determine if deduction backup includes a tag, label, etc. for which data is missing and may predict the missing value. As another example, deductions management system 106 may determine that data within a bounded area of a template (or a predicted bounded area, as noted above) may include incomplete or missing data. Deductions management system 106 may then predict a value for the incomplete or missing data.

In yet another implementation, deductions management system 106 may implement a machine learning algorithm when pairing deduction charges with active promotions. For example, deductions management system 106 may determine that an exact promotion match for a given deduction charge cannot be found within promotions data source 116. In response, deductions management system 106 may execute a machine learning algorithm that predicts which of the currently available promotions is a most likely match for the given deduction charge.

In general, each of the foregoing machine learning algorithms may be developed using respective training data prior to implementation. However, deductions management system 106 may be configured to dynamically update and improve each algorithm as well. For example, following application of a machine learning algorithm, the output (e.g., one or more predictions) of the algorithm may be presented to a user for review and verification. Deductions management system 106 may then use the feedback to further train and refine the corresponding machine learning algorithm.

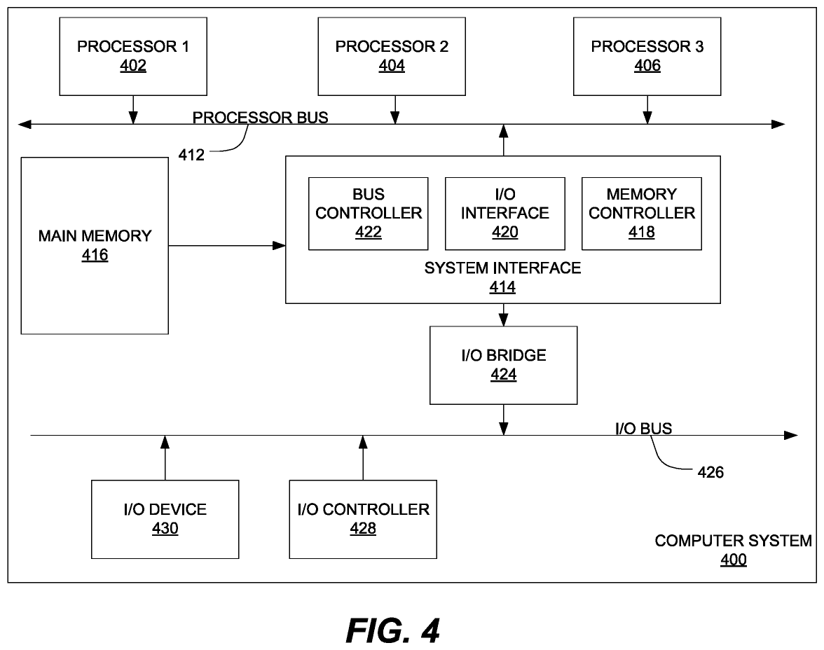

FIG. 4 is a block diagram illustrating an example of a computing device or computer system 400 which may be used in implementing the embodiments of the systems and methods disclosed above. In particular, the computing device of FIG. 4 is one embodiment of the computing system 108, any of the remote computing devices 102A-102N illustrated in FIG. 1, or any other computing device that otherwise performs one of more of the operations described above. The computer system 400 includes one or more hardware processors 402-406. Processors 402-406 may include one or more internal levels of cache (not shown) and a bus controller 422 or bus interface unit to direct interaction with the processor bus 412. Processor bus 412, also known as the host bus or the front side bus, may be used to couple processors 402-406 with a system interface 414. System interface 414 may be connected to processor bus 412 to interface other components of computer system 400 with processor bus 412. For example, system interface 414 may include a memory controller 418 for interfacing a main memory 416 with processor bus 412. Main memory 416 may include, without limitation, one or more memory cards and a control circuit (not shown). System interface 414 may also include an input/output (I/O) interface 420 to interface one or more I/O bridges (e.g. I/O bridge 424) or I/O devices with the processor bus 412. One or more I/O controllers and/or I/O devices may be connected with the I/O bus 426, such as I/O controller 428 and I/O device 430, as illustrated.

I/O device 430 may also include an input device (not shown), such as an alphanumeric input device, including alphanumeric and other keys for communicating information and/or command selections to processors 402-406. Another type of user input device includes cursor control, such as a mouse, a trackball, or cursor direction keys for communicating direction information and command selections to processors 402-406 and for controlling cursor movement on the display device.

Computer system 400 may include a dynamic storage device, referred to as main memory 416, or a random access memory (RAM) or other computer-readable devices coupled to processor bus 412 for storing information and instructions to be executed by processors 402-406. Main memory 416 also may be used for storing temporary variables or other intermediate information during execution of instructions by processors 402-406. Computer system 400 may include a read only memory (ROM) and/or other static storage device coupled to processor bus 412 for storing static information and instructions for processors 402-406. Any such memory may generally be a non-transitory computer-readable medium. The system set forth in FIG. 4 is but one possible example of a computer system that may employ or be configured in accordance with aspects of the present disclosure.

According to one embodiment, at least some of the above methods and techniques described herein may be performed by computer system 400 in response to one or more of processors 402-406 executing one or more sequences of one or more machine-readable instructions contained in main memory 416. These instructions may be read into main memory 416 from another machine-readable medium, such as a storage device. Execution of the sequences of instructions contained in main memory 416 may cause processors 402-406 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 416. Common forms of machine-readable media may include, but are not limited to, magnetic storage media; optical storage media; magneto-optical storage media; read only memory (ROM); random access memory (RAM); erasable programmable memory (e.g., EPROM and EEPROM); flash memory; or other types of media suitable for storing electronic instructions.

Embodiments of the present disclosure include various operations, which are described in this specification. The operations may be performed by hardware components or may be embodied in machine-executable instructions, which may be used to cause a general-purpose or special-purpose processor programmed with the instructions to perform the operations. Alternatively, the operations may be performed by a combination of hardware, software, and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the methods can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a computer-readable storage medium having stored thereon instructions, which may be used to program a computing system (or other electronic devices) to perform a process according to the present disclosure. A computer-readable storage medium includes any mechanism for storing information in a form (e.g., software, processing application) readable by a computer. The computer-readable storage medium may include, but is not limited to, optical storage medium (e.g., CD-ROM), magneto-optical storage medium, read only memory (ROM), random access memory (RAM), erasable programmable memory (e.g., EPROM and EEPROM), flash memory, or other types of medium suitable for storing electronic instructions. Data stores and data structures may be implemented as relational databases, non-relational databases, object oriented databases, and other data storage architectures and may use tables, objects, columns, pointers, and the like in implementing, for example, nodes, edges, references, etc.

The description above includes example systems, methods, techniques, instruction sequences, and/or computer program products that embody techniques of the present disclosure. However, it is understood that the described disclosure may be practiced without these specific details.

While the present disclosure has been described with references to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method of processing deductions for promotions comprising, at a computing system:
receiving a deduction backup including a deduction charge;
extracting a detail of the deduction charge included in the deduction backup;
generating a deduction charge record corresponding to the deduction charge, the deduction charge record including the detail of the deduction charge extracted from the deduction backup;
determining whether the deduction charge is valid by comparing one or more fields of the deduction charge record to criteria for one or more active promotions; and
updating the deduction charge record based on whether the deduction charge meets the criteria of at least one of the one or more active promotions.
